(19) United States
(12) Patent Application Publication
(10) Pub. No.: US 2015/0108871 A1
(43) Pub. Date: Apr. 23, 2015

(54) ULTRASONIC TRANSDUCER WITH DIELECTRIC ELASTOMER AS ACTIVE LAYER

(71) Applicant: SYDDANSK UNIVERSITY, Odense (DK)

(72) Inventors: Benny Larsen, Soenderborg (DK); Morten Willatzen, Soenderborg (DK); Dan-Mihai Timofte, Soenderborg (DK)

(21) Appl. No.: 14/404,742

(22) PCT Filed: May 30, 2013
(86) PCT No.: PCT/DK2013/050165

§ 371 Date: Dec. 1, 2014

(30) Foreign Application Priority Data
Jun. 1, 2012 (DK) PA 2012 70296

(51) Int. Cl. H02N 1/00

(52) U.S. Cl. CPC H02N 1/006
USPC 310/300

(57) ABSTRACT

There is provided a new type of ultrasound transducer, where a Dielectric Elastomer (DE) material is used as the active layer (actuation and/or sensing). Such a transducer operates by applying a combination of a DC and an AC voltage signal to achieve frequencies above 100 kHz. The DE material is typically sandwiched between two planar electrodes.

### FIELD OF THE INVENTION

The present invention relates to the use of a Dielectric Elastomer (DE) material as the active layer (actuation and/or sensing) in an ultrasound transducer. More specifically the transducer operates by applying a combination of a DC and an AC voltage signal to achieve frequencies above 100 kHz.

### BACKGROUND OF THE INVENTION

Ultrasonic transducers have been in use for many years and are particularly useful for e.g. medical imaging. Pulses of high frequency electrical energy applied to the elements of the transducer cause ultrasonic energy to be transmitted through a medium. The ultrasonic energy is reflected back toward the same transducer or received by a physically distinct transducer possibly of the same type. In receiver mode, an electrical signal is generated in the receiving transducer in response to detection of the received ultrasonic energy.

The transducers employed in ultrasonic imaging instruments are a subject of intense research and development activities, as is the associated signal generation and processing equipment employed to generate the drive signals and to process the received signals, so as to provide increasingly more detailed and readily interpreted images. More particularly, it is known to use multiple-element transducers, each of the elements being individually electrically addressed, so that the timing of the drive signals applied to each of the elements can be separately controlled. In this way, for example, an ultrasonic beam emitted by a group of elements can be focused at a desired depth in the structure, or steered in a desired direction.

Typical ultrasonic transducer elements are piezoelectric members formed of a wide variety of ceramic and crystalline materials. Various species of lead-zirconate-titanate (PZT) ceramics are currently the most popular piezoelectric materials for ultrasonic applications. Other materials generally equivalent to PZT ceramics for the purposes of this application (where not otherwise specified) include single crystal relaxors, and biased electrorestrictor materials. Typical compositions of these materials and suitable techniques for their processing are well known to those of skill in the art.

Dielectric elastomers (DE) belong to an emerging smart material that has gained increasing attention from scientists and engineers over the last decade. DEs, when utilized as actuators, have the potential to be an effective replacement for many conventional actuators due to their light weight, noiseless operation, large strain, modest force density, and fast response time. DE actuators are constructed from thin sheets of DE material sandwiched between compliant electrodes. The actuation principle of DE actuators is based on the electrostatic pressure being induced between oppositely charged electrodes. The electrostatic pressure causes a compression of the DE sheets in the thickness direction. The thickness compression results in an extension of the material in the plane perpendicular to the thickness direction. Although the physical actuation principle of DE actuators can be easily understood, predicting the actuation for a given electrical stimulus is not as straightforward. Extensive research has been dedicated to develop models that can predict the electromechanical behavior of DE.

The basic structure of DEs consists of a thin elastomer film sandwiched between two compliant electrodes. If an electric field is applied across the electrodes, the electrostatic attraction between different charges on the two electrodes and the repulsion forces of the like charges on each electrode will generate a stress on the film, causing it to decrease in thickness and expand in area. Usually elastomers are essentially incompressible, so any decrease in the thickness results in an increase in the planar area. The operating voltages for DE films 10-100 μm in thickness vary from 500 V to 10 KV and the driving currents are very low. Theoretically the device will only consume power during a thickness reduction, but because there will always be a leakage current the DE will consume a small amount of power when maintained in a stable actuation state.

Carpi et al (Dielectric Elastomers as Electromechanical Transducers: Fundamentals, Materials, Devices, Models and Applications of an Emerging Electroactive Polymer Technology (10 Jan. 2008); pages: 124, 314-316, 320) describe the use of DE in loudspeaker membranes. In contrast to ultrasound transducers loudspeakers are normally operated at frequencies far below 100 kHz.

Since a DE sheet can be regarded as a capacitor, i.e., an insulating material sandwiched between conducting electrodes, applying a time-varying stimulus will introduce a time-varying mechanical response. Hence, a dynamic electromechanical model is necessary to account for the capacitive and viscoelastic properties of DE. In particular high frequencies (above 100 kHz) pose significant viscoelastic challenges.

### SUMMARY OF THE INVENTION

The present inventors have surprisingly found that, despite the expected viscoelastic challenges at high frequencies, DE can be used as active layer in ultrasound applications, such as in ultrasound transducers for medical imaging, at frequencies well above 100 kHz.

The present inventors have realized a method of using a Dielectric Elastomer (DE) material as the active layer of an ultrasound transducer operating at frequencies above 100 kHz. This is unexpected since the performance of the DE material would normally be inferior above 100 kHz due to viscous loses. The present inventors have shown that a DC bias in combination with AC signals overcome this problem.

The inventors have found that the DC bias amplifies the emitted acoustic signal whereby large currents can be avoided. This is because the system is non-linear in contrast to a piezoelectric ultrasonic transducer. The softness of the material (low Young's modulus) enables thickness related resonance frequencies at frequencies lower than existing technologies (primarily ceramic piezoelectric systems). Hence the invention is based on the use of the non-linear effect to increase the acoustic signal without having to drive the ultrasonic transducer with a high electrical current, and the small Young modulus to drive the transducer resonance frequency.

Specifically the present invention provides in a first aspect a method of using a Dielectric Elastomer (DE) material as the active layer of an ultrasound transducer operating at frequencies above 100 kHz, preferably above 150 kHz, such as 200 kHz, by applying a combination of a DC bias, typically above 1000 volts, and an AC voltage signal. The DE material is typically sandwiched between two planar electrodes. In a preferred embodiment of the present invention the DE material is selected from the group consisting essentially of silicone, fluorosilicone, fluoroelastomer, natural rubber, polybutadiene, nitrile rubber, isoprene, and ethylene propylene diene.

In a second aspect the present invention provides an ultrasonic transducer system comprising:
an elastomeric dielectric polymer layer as active layer having a first surface and a second surface;
a first electrode layer contacting said first surface; and a second electrode layer contacting said second surface;
DC and AC generator;
a control unit that triggers the DC and AC generator to apply a combination of a DC bias and an AC voltage signal at frequencies above 100 kHz, preferably above 150 kHz, such as 200 kHz.

The electrode layer is preferably made from graphite, carbon, conductive polymers, or thin metal films.

The electrode layers of the ultrasonic transducer system are preferably coupled to both a DC and AC generator.

In comparison with other technologies, the present ultrasonic transducer principle provides superior operation at a different frequency scale for specified physical dimensions. In many applications, physical dimensions are subject to strong restrictions either due to mechanical stability requirements, size restrictions, or cost considerations. The DE material offers many advantages: It is very flexible and hence mechanically stable to a large extent, dielectric breakdown occurs at very large electric fields, it is cheap, environmentally friendly (in opposition to piezoelectric ceramics) and can be manufactured as thin films (dimensions down to several tens of microns at present). The application of DE materials as ultrasonic transducers takes advantage of these material properties. Potential device disadvantages include viscous loss mechanisms. Further electric contacting is an obstacle leading to losses or even failure but improvements are expected in the near future.

### BRIEF DESCRIPTION OF THE DRAWINGS

FIG. 1 shows pressure as a function of V0 with no resistance connected to the circuit, Vcritical=258 V.

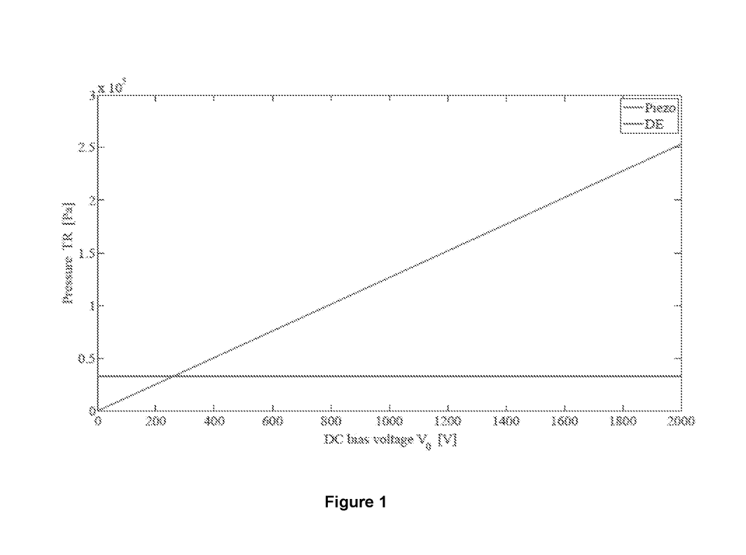

FIG. 2 shows pressure as a function of V0 with a 75 ohm resistance connected in series with the circuit, Vcritical=254 V.

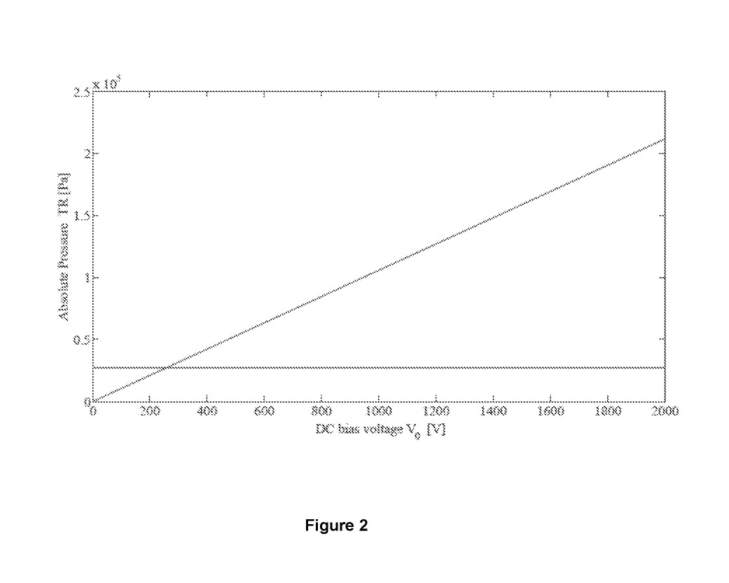

FIG. 3 shows pressure as a function of V0 with a 1700 ohm resistance connected in series with the circuit, Vcritical=650 V.

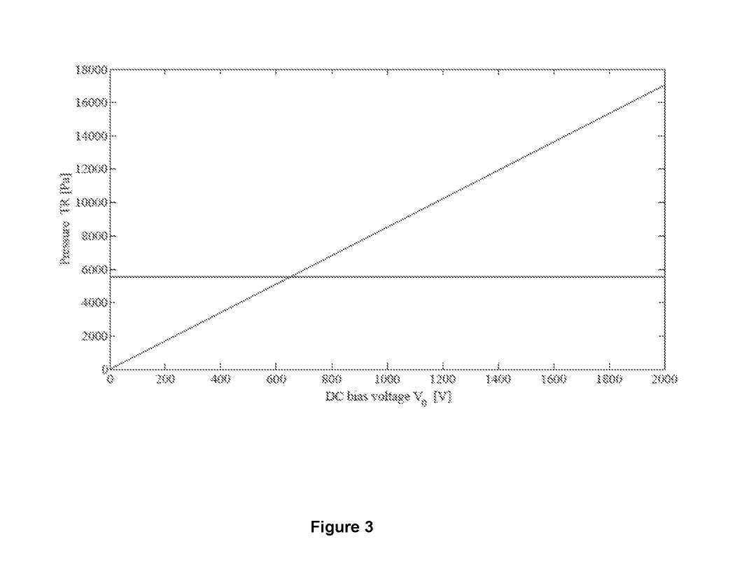

### DETAILED DESCRIPTION OF THE INVENTION

In the appended figures it is shown that the DE ultrasonic transducer is superior to a traditional PZT piezo-ceramic ultrasonic transducer at sufficiently high applied DC voltages for a given AC voltage.

Specifically a DE sheet is a dielectric material sandwiched between compliant electrodes; hence, a DE sheet can be modeled as a strain dependent variable plate capacitor. However, dielectric materials (including DEs) are non-ideal as they also exhibit a certain conducting current. Therefore, a more realistic model of a DE actuator is a variable capacitor in parallel with a resistor. A DE's electrode resistance and resistances in wiring and connections also influence the electric circuit dynamics of the system and must be included in the electrical model.

The polymer dielectric used in the present invention allows greater power output at a given voltage, since the electrostatic energy is multiplied by the dielectric constant of the polymer (typically between 2 and 10). In practice, the polymer dielectric will have a greater breakdown voltage than air, largely due to the fact that the polymer prevents the accumulation of particulates on the electrodes. Thus, the electric field generated by the applied voltage can be greater than air-gap devices, further increasing the power output capabilities of the invention (power output is proportional to the square of the electric field).

The invention may also be considered to operate based on the electrostriction of a polymer film. However, it differs from other electrostrictive devices that produce sound primarily by the changing the thickness of a polymer film (or stack of films) due to the electrostrictive effect. In contrast, the invention produces ultrasound by using in-plane strains to induce essentially diaphragm bending of the film. The apparent stiffness and mass of a polymer film in response to an applied force or pressure can be orders of magnitude less than that for compression of the solid polymer as in other electrostrictive devices. The air driven by the film has low mass and stiffness. Thus, the invention is better coupled acoustically to the air resulting in greater acoustic output (per surface area and per weight) for a given electrical input.

The invention depends on a form of electrostriction of a polymer dielectric. However, the mechanism of actuation in the invention is believed to be different from the electrostrictive devices that rely on the change in thickness of the polymer to produce motion in that here the strain results principally from the external forces caused by the electrostatic attraction of the electrodes rather than just from internal intermolecular forces. This distinction gives the invention the advantage that the dielectric materials can be selected based on properties such as high dielectric strength, high volume resistivity, low modulus of elasticity, low hysteresis, and wide temperature operating range (which give advantages of high energy density, high electrical to mechanical energy conversion efficiency, large strains, high mechanical efficiency and good environmental resistance, respectively) rather than just the magnitude of the electrostrictive response for a given field.

The use of polymers with low moduli of elasticity also allows for high acoustic output per surface area and per weight at lower driving voltages than possible with other devices since the resulting motion is greater with the more compliant materials at a given voltage.

The individual elements that compose the speaker in the invention can be extremely small or large. If small, the elements can be made with microfabrication techniques. Other speakers that function based upon the bending of a small microfabricated diaphragm exist.

A preferred dielectric elastomer used in the present invention is PolyPower DE, which is a silicone DE manufactured by Danfoss PolyPower A/S, Denmark. PolyPower DEs, used for the construction of the actuators under consideration, are produced in thin sheets of 40-μm thickness. A corrugated microstructure is imprinted on one side of the thin sheet with amplitude and period of the corrugations given by 5 and 10 μm, respectively. A 100 nm silver electrode is then sputtered on the corrugated surface using a physical vapor deposition process. The metallic electrodes increase the dynamic range of the PolyPower DE; however, due to high stiffness and no prestraining, the tubular actuators have smaller strain than conventional tubular DE actuators. For actuator fabrication, a laminate of two sheets placed back to back is used. The resulting laminate has a thickness of 80 μm with corrugated electrodes on both the upper and lower surfaces. Charging the corrugated electrodes reduces the thickness of the laminate causing elongation in the compliant direction. The DE laminate is then, in a semiautomated process, rolled to form a tubular actuator. Note that the actuators have an active length, which is the area being actuated and passive areas at either side to avoid electrical short circuiting.

A very important factor is the developing of compliant electrodes if good DE performance is desired. The compliant electrode should maintain high conductivity at large strains and good stability. Commonly used materials include carbon grease, carbon powder and graphite. Depending on the applications these solutions can have both advantages and disadvantages. For example carbon powder and graphite are better suited for multilayer devices but they tend to loose conductivity at high strains. On the other hand, carbon grease provides good conductivity even at high strains making them the most used solution

1. Method of using a Dielectric Elastomer (DE) material as the active layer of an ultrasound transducer operating at frequencies above 100 kHz by applying a combination of a DC bias and an AC voltage signal.

2. The method according to claim 1, wherein the DC bias is at least 1000 volts.

3. The method according to claim 1, wherein the DE material is sandwiched between two planar electrodes.

4. The method according to claim 1, wherein the DE material is selected from the group consisting essentially of silicone, fluorosilicone, fluoroelastomer, natural rubber, polybutadiene, nitrile rubber, isoprene, and ethylene propylene diene.

5. An ultrasonic transducer system comprising:
an elastomeric dielectric polymer layer as active layer having a first surface and a second surface;
a first electrode layer contacting said first surface; and a second electrode layer contacting said second surface;
DC and AC generator;
a control unit that triggers the DC and AC generator to apply a combination of a DC bias and an AC voltage signal at frequencies above 100 kHz.

6. The ultrasonic transducer system of claim 5, wherein the DC bias is at least 1000 volts.

7. The ultrasonic transducer system of claim 5, wherein said electrode layer is made from the group consisting essentially of graphite, carbon, conductive polymers, and thin metal films

8. The ultrasonic transducer system of claim 5, wherein the elastomeric dielectric polymer layer comprises a material selected from the group consisting essentially of silicone, fluorosilicone, fluoroelastomer, natural rubber, polybutadiene, nitrile rubber, isoprene, and ethylene propylene diene.

9. The ultrasonic transducer system of claim 5, wherein the electrode layers are coupled to both a DC and AC generator to achieve ultrasound frequencies above 100 kHz, preferably above 150 kHz, such as 200 kHz.
